(19) United States
(12) Patent Application Publication
(10) Pub. No.: US 2013/0003030 A1
(43) Pub. Date: Jan. 3, 2013

(54) LASER ABLATION TOOLING VIA DISTRIBUTED PATTERNED MASKS

(75) Inventor: Thomas R.J. Corrigan, Saint Paul, MN (US)

(73) Assignee: 3M Innovative Properties Company

(21) Appl. No.: 13/613,427

(22) Filed: Sep. 13, 2012

Related U.S. Application Data
(62) Division of application No. 12/562,369, filed on Sep. 18, 2009.

(51) Int. Cl. G03B 27/42

(52) U.S. Cl. 355/53

(57) ABSTRACT

A distributed patterned mask for use in a laser ablation process to image a complete pattern onto a substrate. The mask has a plurality of apertures for transmission of light and non-transmissive areas around the apertures. When the apertures for the distributed pattern are repeatedly imaged on a substrate, structures within the distributed pattern merge within different areas of the imaged pattern to create the complete pattern with distributed stitch lines in order to reduce or eliminate the stitching effect in laser ablation. The mask can also form a sparse and distributed pattern including apertures that individually form merging portions of the complete pattern and collectively form a distributed pattern.

### CROSS REFERENCE TO RELATED APPLICATION

This application is a divisional of U.S. application Ser. No. 12/562,369, filed Sep. 18, 2009, now pending, the disclosure of which is incorporated by reference in its entirety herein.

### BACKGROUND

Excimer lasers have been used to ablate patterns into polymer sheets using imaging systems. Most commonly, these systems have been used to modify products, primarily to cut holes for ink jet nozzles or printed circuit boards. This modification is performed by overlaying a series of identical shapes with the imaging system. The mask of constant shapes and a polymer substrate can be held in one place while a number of pulses from the laser are focused on the top surface of the substrate. The number of pulses is directly related to the hole depth. The fluence (or energy density) of the laser beam is directly related to the cutting speed, or microns of depth cut per pulse (typically 0.1-1 micron for each pulse).

Moreover, 3D structures can be created by ablating with an array of different discrete shapes. For instance, if a large hole is ablated into a substrate surface, and then smaller and smaller holes are subsequently ablated, a lens like shape can be made. Ablating with a sequence of different shaped openings in a single mask is known in the art. The concept of creating that mask by cutting a model (such as a spherical lens) into a series of cross sections at evenly distributed depths is also known.

### SUMMARY

A distributed patterned mask, consistent with the present invention, can be used in a laser ablation process to image a substrate. The mask has apertures for transmission of light and non-transmissive areas around the apertures. The apertures collectively form a distributed portion of a complete pattern, and when the apertures in the mask are repeatedly imaged onto the substrate, structures within the distributed portion meet or stitch together within different areas of the imaged pattern to create the complete pattern on the substrate with distributed stitch lines.

A sparse and distributed patterned mask, consistent with the present invention, can also be used in a laser ablation process to image a substrate. The mask has apertures for transmission of light and non-transmissive areas around the apertures. The apertures individually form portions of a complete pattern and collectively form a distributed portion of the complete pattern, and at least a portion of the non-transmissive areas exist on the mask in regions between the apertures that correspond to non-imaged regions on the substrate that are subsequently imaged by the apertures to create the complete pattern. When the apertures in the mask are repeatedly imaged onto the substrate, structures within the distributed portion meet or stitch together within different areas of the imaged pattern to create the complete pattern on the substrate with distributed stitch lines.

A mask is a discrete region of apertures that can be imaged at a single time by the laser illumination system. More than one mask may exist on a single glass plate if the plate is much larger than the field of view of the illumination system. Changing from one mask to another may include moving the glass plate to bring another region into the laser illumination field of view.

Methods, consistent with the present invention, include repeatedly imaging a substrate using a distributed patterned mask, or a sparse and distributed patterned mask, to form a complete pattern on the substrate with distributed stitch lines.

Microreplicated articles, consistent with the present invention, have arrays of repeating features formed from a distributed portion of a complete pattern, or sparse and distributed portions of the complete pattern, and the arrays have structures repeatedly meeting within different areas of the imaged pattern to create the complete pattern with distributed stitch lines.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of a system for performing laser ablation on a flat substrate;

FIG. 2 is a diagram of a system for performing laser ablation on a cylindrical substrate;

FIG. 3 is a diagram of a mask having apertures in a regular pattern designed to ablate a continuous structure that leaves a pattern of square posts on the substrate;

FIG. 4 is a diagram illustrating ablating the pattern of the mask in FIG. 3;

FIG. 5 is an image of the stitching effect resulting from ablating a pattern similar to the pattern of the mask in FIG. 3;

FIG. 6 is a diagram of a mask having apertures in a distributed pattern designed to ablate a continuous structure that leaves a pattern of square posts on the substrate;

FIG. 7 is a diagram illustrating ablating the distributed pattern of the mask in FIG. 6;

FIG. 8 is a diagram of a mask having ring-like apertures designed to ablate a pattern of rings;

FIG. 9 is a diagram of a mask having a sparse and distributed pattern of apertures that could produce the pattern of rings;

FIG. 10 is a diagram illustrating ablating the sparse and distributed pattern of the mask in FIG. 9;

FIG. 11 is a diagram of a mask having apertures in a regular pattern designed to ablate a continuous structure that leaves a pattern of hexagonal posts on the substrate; and

FIG. 12 is a diagram of a mask having apertures in a sparse and distributed pattern designed to ablate a continuous structure that leaves a pattern of hexagonal posts on the substrate.

### DETAILED DESCRIPTION

Embodiments of the present invention relate to a method of creating continuous structures, or structures whose ablated area is longer in at least one dimension than the dimension of the illuminated area in that direction. These structures are made from a mask having apertures that form a distributed portion of a complete pattern such that when the apertures in the mask are repeatedly imaged onto a substrate, structures within the distributed portion merge within different areas of the imaged pattern to create the complete pattern on the substrate with distributed stitch lines. Examples of continuous structures include continuous grooves with triangular cross sections such as optical prisms, continuous arrays of inverse cell shapes where a rib between cells is machined such as inverse tooling of individual recessed areas, or a continuous trench for microfluidics.

### Laser Ablation Systems

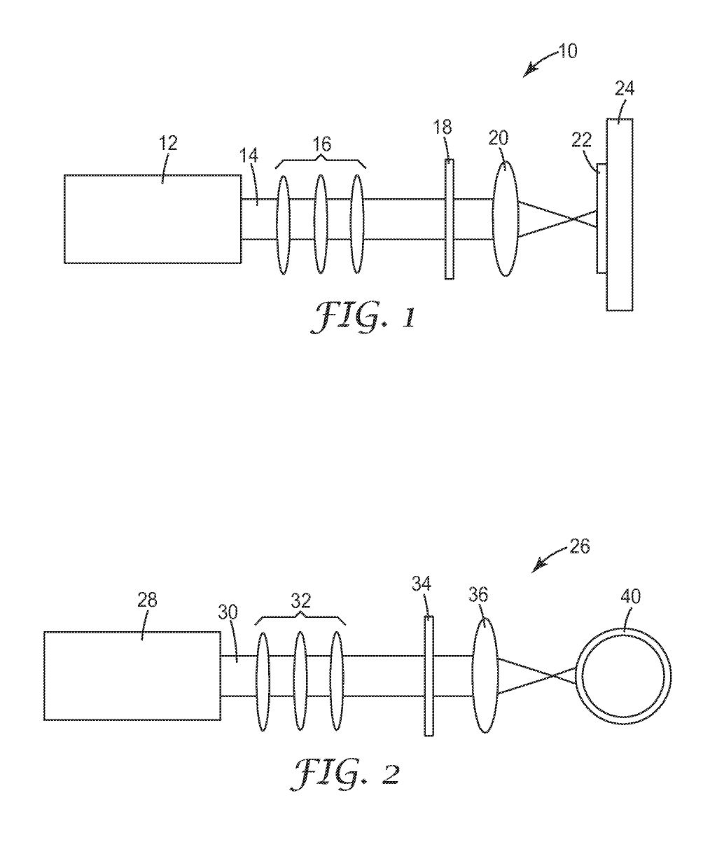

FIG. 1 is a diagram of a system 10 for performing laser ablation on a substantially flat substrate. System 10 includes a laser 12 providing a laser beam 14, optics 16, a mask 18, imaging optics 20, and a substrate 22 on a stage 24. Mask 18 patterns laser beam 14 and imaging optics 20 focus the patterned beam onto substrate 22 in order to ablate material on the substrate. Stage 24 is typically implemented with an x-y-z stage that provides for movement of the substrate, via stage 24, in mutually orthogonal x- and y-directions that are both also orthogonal to laser beam 14, and a z-direction parallel to laser beam 14. Therefore, movement in the x- and y-directions permits ablation across substrate 22, and movement in the z-direction can assist in focusing the image of the mask onto a surface of substrate 22.

FIG. 2 is a diagram of a system 26 for performing laser ablation on a substantially cylindrical substrate. System 26 includes a laser 28 providing a laser beam 30, optics 32, a mask 34, imaging optics 36, and a cylindrical substrate 40. Mask 34 patterns laser beam 30 and imaging optics 36 focus the patterned beam onto substrate 40 in order to ablate material on the substrate. The substrate 40 is mounted for rotational movement in order to ablate material around substrate 40 and is also mounted for movement in a direction parallel to the axis of substrate 40 in order to ablate material across substrate 40. The substrate can additionally be moved parallel and orthogonal to the beam 30 to keep the image of the mask focused on the substrate surface.

The masks 18 and 34, or other masks, have apertures to allow transmission of laser light and non-transmissive areas around the apertures to substantially block the laser light. One example of a mask includes a metal layer on glass with a photoresist in order to make the apertures (pattern) via lithography. The mask may have varying sizes and shapes of apertures. For example, a mask can have round apertures of varying diameters, and the same position on the substrate can be laser ablated with the varying diameter apertures to cut a hemispherical structure into the substrate.

Substrates 22 and 40 can be implemented with any material capable of being machined using laser ablation, typically a polymeric material. In the case of cylindrical substrate 40, it can be implemented with a polymeric material coated over a metal roll. Examples of substrate materials are described in U.S. Patent Applications Publication Nos. 2007/0235902A1 and 2007/0231541A1, both of which are incorporated herein by reference as if fully set forth.

Once the substrates have been machined to create microstructured articles, they can be used as a tool to create other microreplicated articles, such as optical films. Examples of structures within such optical films and methods for creating the films are provided in U.S. patent application Ser. No. 12/275,631, entitled “Curved Sided Cone Structures for Controlling Gain and Viewing Angle in an Optical Film,” and filed Nov. 21, 2008, which is incorporated herein by reference as if fully set forth.

The microreplicated articles can have features created by a laser imaging process using distributed patterned, or sparse and distributed patterned, masks as described below. The term “feature” means a discrete structure within a cell on a substrate, including both a shape and position of the structure within the cell. The discrete structures are typically separated from one another; however, discrete structures also includes structures in contact at the interface of two or more cells.

Laser machining of flat and cylindrical substrates is more fully described in U.S. Pat. No. 6,285,001 and U.S. Patent Application Publication No. 2009/0127238, both of which are incorporated herein by reference as if fully set forth.

### Continuous Patterns

One approach to creating continuous structures includes making a mask which connects one end of a pattern in the mask with the other end. For example, to create an array of square posts, a continuous array of structures can be created as shown in FIG. 3. Mask 42 in FIG. 3 includes continuous arrays of transmissive areas 44 surrounded by non-transmissive areas 46. Ablating of a substrate occurs through repeatedly imaging the pattern formed by transmissive areas 44, creating square posts on the substrate. However, when this pattern is ablated a stitching effect will be produced where the left edge 52 and top edges 54 of mask 42 merge with the right edge 56 and bottom edge 58.

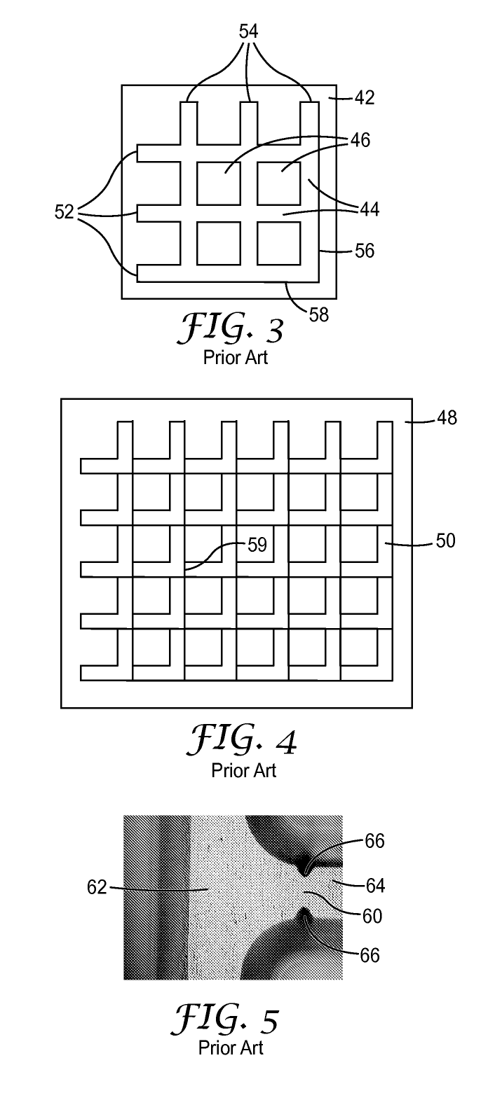

For the structures shown in mask 42, the stitching effect would appear as shown in FIG. 4. Substrate 48 in FIG. 4 has ablated portions 50 formed from repeatedly imaging mask 42 over it in different positions and includes coincident stitching lines between the features such as stitching lines 59. The stitching effect will increase with increasing depth of cut through the ablation. Misalignment of the mask with the substrate, misfocussing of the mask on the substrate, and inhomogeneity of the laser beam will also increase the effect. Depending on how the mask is overlaid on itself through repeated imaging of it, the effect can appear at every feature as shown in FIG. 4, or it can appear at a regular interval such as every other feature or every fourth feature. If the effect appears at less than every feature it will be worse.

The stitching effect originates in the fact that no imaging system has infinite resolution and infinite edge definition of the beam. The intensity of light at the edge of the beam is nominally Gaussian. This means that each image is not cut infinitely sharp into the substrate. Every time two edges just meet or merge to “stitch” together from ablation through the mask they leave extra material non-ablated at the interface. The cumulative effect leaves a mark in the structure, as illustrated in the image in FIG. 5 where a feature 62 was “stitched” with a feature 64 and left extra material 66, not ablated, in the substrate at coincident stitching lines 60. This extra material 66 is undesirable in that it results in an imperfection in the ablated areas on the substrate and thus can also produce a corresponding imperfection in microreplicated articles made from the substrate. If the two edges are overlapped in an attempt to remove this effect, then extra material will be ablated in the overlap region creating a different defect where excess material is removed instead of excess material being left. With the distributed stitching approach, the merging regions or stitch areas can overlap slightly, fall just short of each other or exactly meet. The cumulative effect of any of those conditions will be a noticeable defect that is greatly reduced by distributing the stitching interface.

### Distributed Patterns

An improved approach to imaging patterns distributes the stitching pattern more widely on the mask through a distributed portion of a complete pattern. For example, the mask pattern used in FIG. 3 could be distributed as shown in FIG. 6. Mask 68 in FIG. 6 includes continuous arrays of transmissive areas 70 surrounded by non-transmissive areas 72. Ablating of a substrate occurs through repeatedly imaging the pattern formed by transmissive areas 70, creating square posts on the substrate. Mask 68 also includes a left edge 69 and top edge 71, as well as bottom 73 and right edge 75, formed from structures of varying lengths. These edges with varying length structures in the pattern results in merging within different areas of the imaged pattern to create the complete pattern on the substrate with distributed stitching lines. The merging structures in different areas can have some overlap area in common The distribution of merging structures means that the stitching lines occur in different locations, resulting in distribution of them.

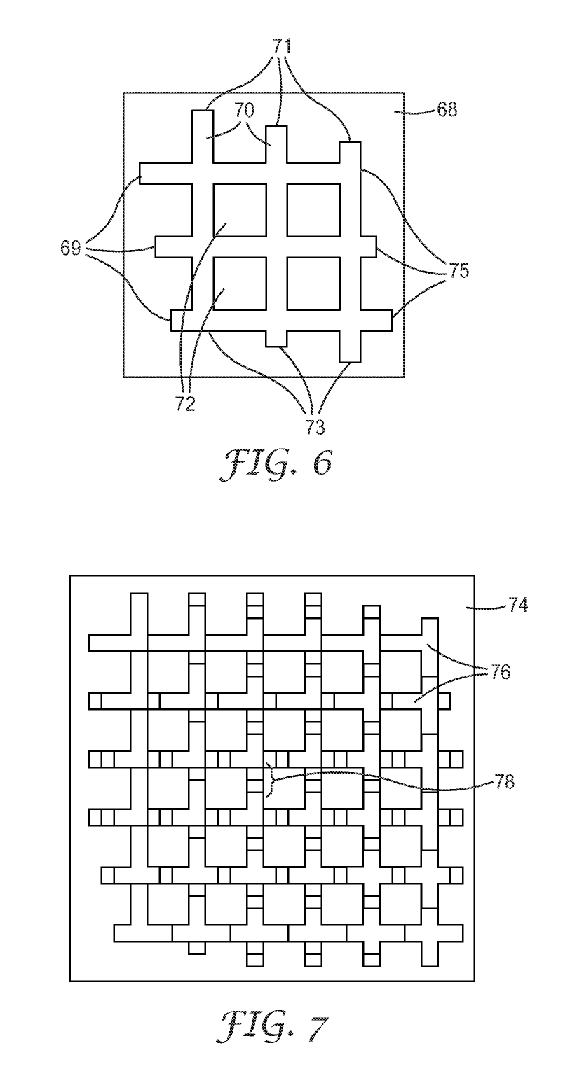

The resulting stitch pattern from repeatedly imaging mask 68 is shown in FIG. 7. Substrate 74 in FIG. 7 has ablated portions 76 formed from repeatedly imaging mask 68 over it in different position and, as shown in section 78 for example, it includes one-third as many stitch lines on top of each other for the same number of imaging steps compared with imaging mask 42. In other words, the stitch lines have been distributed to different sections on the ablated areas of the substrate. The stitching effect is thus removed or at least reduced from the continuous structures made by the imaging of the mask having the distributed pattern.

Distribution of stitching lines can also be used to reassemble discrete parts that are “cut up” to produce a sparse pattern. The sparse pattern can include, for example, two or more repeating arrays or other series of features, each of which forms a constituent pattern as part of a complete pattern and are interlaced to create the complete pattern. The arrays or series of features can also be distributed in that when they are repeatedly imaged, structures within the constituent patterns merge within different areas of the imaged pattern to create the complete pattern on the substrate with distributed stitch lines.

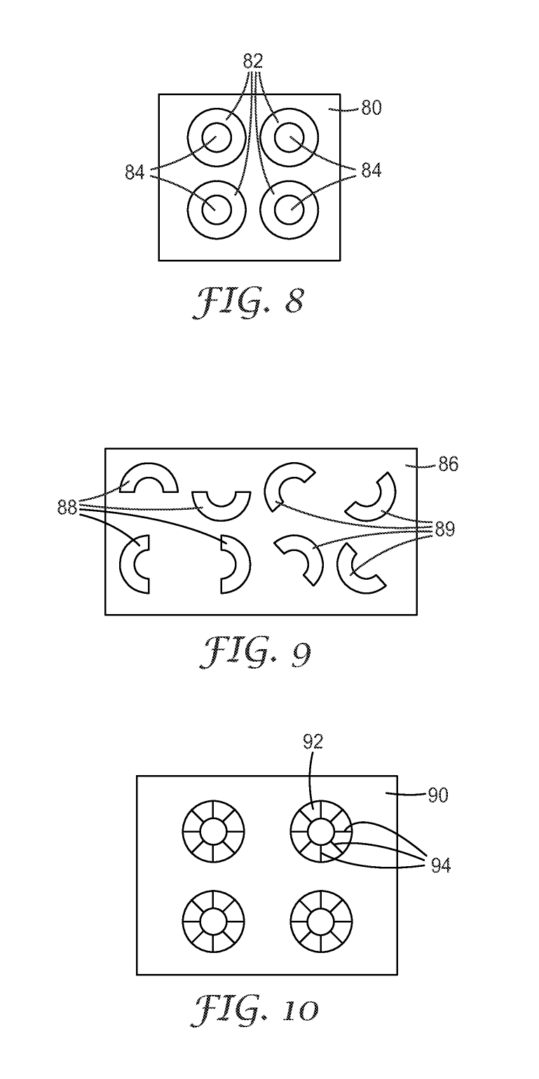

In FIG. 8, a mask 80 illustrates a pattern of continuous ring-like structures having transmissive areas 82 surrounded by non-transmissive areas 84, which can be used to create rings on a substrate by ablating material in the areas corresponding with transmissive areas 82. This ring-like pattern can be made distributed and sparse as shown in FIG. 9. Mask 86 in FIG. 9 includes transmissive areas 88 and 89 surrounded by non-transmissive areas. Transmissive areas 88 and 89 are sparse in that each forms only a portion of the ring-like structure, and they are distributed in that repeatedly imaging of them to form the ring-like structures on a substrate results in different areas of merging to distribute the stitch lines. As shown in FIG. 10, substrate 90 ablated with repeated imaging of mask 86 results in ring-like structures having distributed stitch lines, such as structure 92 having stitch lines 94, resulting from the different lines of merger of transmissive areas 88 and 89.

Examples of sparse patterned masks are described in U.S. patent application Ser. No. 12/275,669, entitled “Laser Ablation Tooling via Sparse Patterned Masks,” and filed Nov. 21, 2008, which is incorporated herein by reference as if fully set forth.

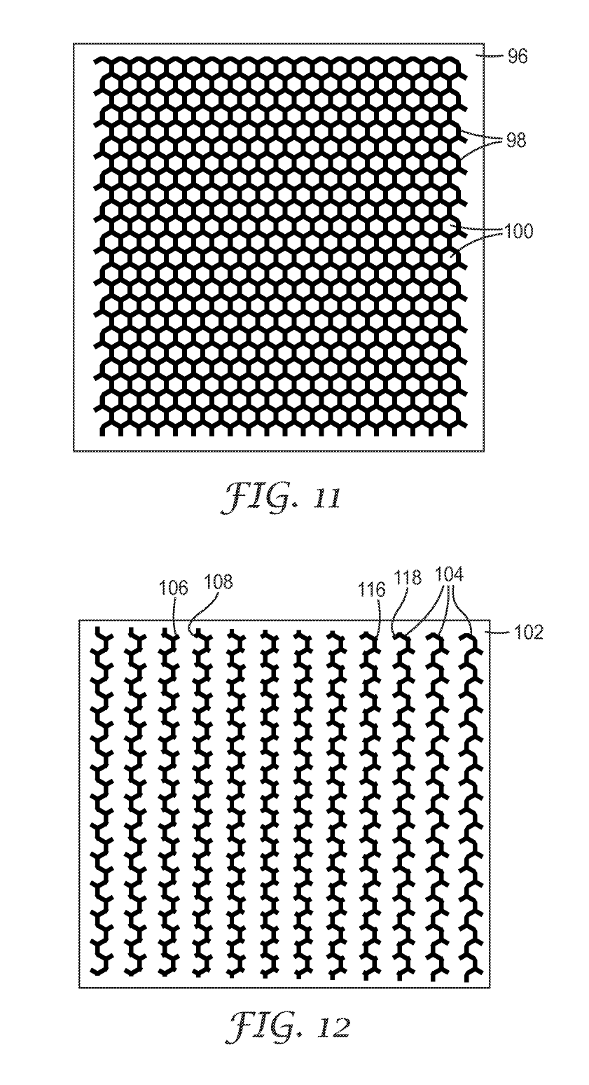

A hexagonal pattern can also be made sparse and distributed as illustrated in FIGS. 11 and 12. As shown in FIG. 11, a mask 96 includes continuous structures (transmissive areas) 98 surrounded by non-transmissive areas 100 to create the hexagonal pattern on a substrate though laser ablation. As shown in FIG. 12, mask 102 includes a sparse and distributed hexagonal pattern. Transmissive areas 104 are sparse in that each forms only a portion of the hexagonal pattern, and they are distributed in that repeatedly imaging of them to form the hexagonal structures results in different areas of merger to distribute the stitch lines. For example, structures 106 and 108 stitch together in different locations than structures 116 and 118 to distribute the stitching of the hexagonal pattern when mask 102 is repeatedly imaged in different locations over a substrate.

1. A method for laser imaging a substrate using a distributed patterned mask, comprising:
imaging the substrate through apertures for transmission of light, wherein non-transmissive areas surround the apertures and wherein the apertures in the mask collectively form a distributed portion of a complete pattern;
moving the mask to a different position relative to the substrate; and
repeating the imaging step,
wherein when the apertures in the mask are repeatedly imaged onto the substrate, structures within the distributed portion merge within different areas of the imaged pattern to create the complete pattern on the substrate with distributed stitch lines.

2. The method of claim 1, wherein the substrate has a substantially flat shape.

3. The method of claim 1, wherein the substrate has a substantially cylindrical shape.

4. The method of claim 1, wherein the imaging step comprises imaging the substrate through a single mask.

5. The method of claim 1, wherein the complete pattern, when created on the substrate, forms a plurality of posts on the substrate.

6. The method of claim 5, wherein the posts have a round shape.

7. The method of claim 5, wherein the posts have a square shape.

8. The method of claim 5, wherein the posts have a hexagonal shape.

9. A method for laser imaging a substrate using a sparse and distributed patterned mask, comprising:
imaging the substrate through first apertures for transmission of light, wherein non-transmissive areas surround the first apertures and wherein the first apertures in the mask individually form first portions of a complete pattern; and
imaging the substrate through one or more second apertures for transmission of light, wherein the non-transmissive areas surround the one or more second apertures and wherein the one or more second apertures in the mask individually form second portions of the complete pattern,
wherein the first apertures and the one or more second apertures collectively form a distributed portion of the complete pattern,
wherein the first apertures and the one or more second apertures together form the complete pattern when the first apertures and the one or more second apertures are individually imaged onto the substrate, and
wherein when the first and the one or more second apertures in the mask are repeatedly imaged onto the substrate, structures within the first and second distributed portions merge within different areas of the imaged pattern to create the complete pattern on the substrate with distributed stitch lines.

10. The method of claim 9, wherein the substrate has a substantially flat shape.

11. The method of claim 9, wherein the substrate has a substantially cylindrical shape.

12. The method of claim 9, wherein the imaging steps comprise imaging the substrate through a single mask.

13. The method of claim 9, wherein the complete pattern, when created on the substrate, forms a plurality of posts on the substrate.

14. The method of claim 13, wherein the posts have a round shape.

15. The method of claim 13, wherein the posts have a square shape.

16. The method of claim 13, wherein the posts have a hexagonal shape.
